(19) United States
(12) Patent Application Publication
(10) Pub. No.: US 2026/0148718 A1
(43) Pub. Date: May 28, 2026

(54) MUSICAL INSTRUMENT BRIDGE SYSTEM

(71) Applicant: Angel's Music, LLC, Spring Hill, FL (US)

(72) Inventor: James Gary Hernon, Spring Hill, FL (US)

(73) Assignee: Angel's Music, LLC, Spring Hill, FL (US)

(21) Appl. No.: 18/962,184

(22) Filed: Nov. 27, 2024

(51) Int. Cl. G10D 3/04

(52) U.S. Cl. CPC G10D 3/04

(57) ABSTRACT

A bridge for a stringed musical instrument is provided. The bridge is machined solid from various metals, selected for their metallurgic and sonorous qualities. It is machined as a movable one-piece solid body and plate, selectively used in combination with a separate machined tremolo block and tremolo arm, or a fixed two-piece system: a body and mounting plate. Increased mass of a rounded, machined design and the qualities of the bridge metals combine to improve sustain of the instrument. The bridge's preferred rounded ergonomic design allows the player hand protection from the string saddles and screws, the bridge itself visually compliments typical guitar contours and provides a surface for branding. It may replace existing bridges or be used in new instruments.

The present disclosure relates to bridges and tremolo assemblies for stringed musical instruments. For example, this disclosure relates to materials and methods of guitar fixed bridges and guitar tremolo assemblies and that incorporate a tremolo sustain block which anchors the ball ends of the instrument strings.

### BACKGROUND

Fixed bridges had been a standard approach used on stringed instruments until floating bridges were invented. However, while floating tremolos and floating bridges are now generally more popular than fixed systems, both floating and non-floating designs are and have been a part of guitars since the 1930s.

In this regard, the very first tremolo system was the Kaufmann Vibrola, first introduced in the 1930s. The very first floating tremolo was launched by Bigsby in the 1940s, originally designed for country artist Merle Travis.

Clarence Leo Fender patented the Fender Telecaster, U.S. Design Pat. No. 164,227, issued on Aug. 14, 1951, as the world's first solid body electric guitar. The Telecaster has a fixed bridge. The Fender Telecaster is the original Fender tone machine and is considered essential in any guitarist's toolkit.

But it was not until Fender released the legendary Stratocaster in 1954, U.S. Pat. No. 2,741,146, issued on Apr. 10, 1956, that the idea of a floating tremolo really took off. The Stratocaster's floating synchronized tremolo equipped bridge brought this type of guitar to the masses. Tremolo blocks, which Fender called bars, were added in the Stratocaster's design.

The concept of a fixed bridge is to provide an anchor for the instrument's strings to the body of the instrument, allowing the strings to travel over the saddles, across the fretboard and then anchored at the head of the instrument with tuning machines. The concept of the tremolo system is to provide a pivoting bridge system anchored to the instrument with limited pivotal movement in order that the tension applied to the strings may be readily varied to produce a tremolo effect. This pivoting bridge system comprises a base that is pivotally connected by bridge pivot screws on the top of the guitar body and connected rigidly to a tremolo block below, with all strings anchored in the tremolo block traveling through the tremolo block to the saddles, across the fretboard and anchored at the head of the neck by tuning machines. The anchoring of each type of bridge to the instrument allows vibrations from the strings when strummed or plucked to travel into the body and enhance the string vibrations that the magnetic pickups transmit to the output jack.

Both the Telecaster fixed bridge and the Stratocaster tremolo bridge are constructed as a rectangular bent metal bridge, with exposed saddles and saddle adjustment screws. The Stratocaster bridge is described in Fender's U.S. Pat. No. 2,741,146: “Each bridge element is formed of a strip of sheet metal bent at its rearward extremity to form a horizontally folded end which receives the corresponding tension screw. The forward portion of each bridge element is folded upwardly and doubled upon itself to form a bridge portion of U-shaped cross-section spaced outwardly of but relatively closely adjacent the fulcrum ridge. At each lateral margin, each bridge portion is screw threaded to receive a height adjustment screw which bears against the base plate. Each bridge element is provided with a slot.” The saddles are described as a bridge element. Fender describes the tremolo block as a bar, with no further description beyond an anchoring point for the tremolo arm.

Bridges are used to provide an anchor for an instrument's strings to the body of the instrument. A fixed bridge is configured for a specific instrument. A tremolo bridge has a tremolo block affixed to the tremolo bridge which serves as an anchor for the ball ends of the strings. In many conventional guitar tremolo systems, incorporating commonly used tremolo sustain blocks, the block is cast metal with minimal mass and sound transmission qualities.

However, there are problems with existing bridges. What is needed are improvements in fixed bridges, tremolo bridges, tremolo sustain blocks, and associated assemblies, materials, and methods. Accordingly, there is a need in the art for improved bridges and associated assemblies, materials, and methods.

### BRIEF DESCRIPTION

In accordance with one aspect of the presently described embodiments, a bridge for stringed musical instruments comprises a bridge body machined solid from metals selected for metallurgic and sound transmission qualities and a bridge plate machined solid from metals selected for metallurgic and sound transmission qualities.

In accordance with another aspect of the presently described embodiments, the bridge body is formed in curved shapes to aesthetically complement typical instrument rounded contours.

In accordance with another aspect of the presently described embodiments, the bridge body is formed in curved shapes and to form an exposed surface area suitable for branding.

In accordance with another aspect of the presently described embodiments, the bridge body has a height sufficient to increase the mass of the bridge body.

In accordance with another aspect of the presently described embodiments, the bridge body has a height sufficient to allow saddle screw heads to be enclosed in the bridge and to protect the player's hand from the saddles and saddle adjustment screws.

In accordance with another aspect of the presently described embodiments, the bridge body and the bridge plate are integral.

In accordance with another aspect of the presently described embodiments, a one-piece tremolo bridge for a stringed musical instrument comprises a bridge body, a bridge plate configured to anchor strings of the stringed musical instrument strings to a body of the stringed musical instrument, wherein the bridge body and bridge plate are integral and machined solid from metals selected for metallurgic and sound transmission qualities, a tremolo block rigidly attached to the bottom of the bridge plate, wherein the tremolo block is machined solid from metals selected for metallurgic and sound transmission qualities and a tremolo arm anchored in the tremolo block configured to pivot the bridge body, the bridge plate and the tremolo block together.

In accordance with another aspect of the presently described embodiments, the tremolo block is machined to accept piezo pickup(s).

In accordance with another aspect of the presently described embodiments, the bridge body is formed in curved shapes to aesthetically complement typical instrument rounded contours.

In accordance with another aspect of the presently described embodiments, the bridge body is formed in curved shapes and to form an exposed surface area suitable for branding.

In accordance with another aspect of the presently described embodiments, the bridge body has a height sufficient to increase the mass of the bridge body.

In accordance with another aspect of the presently described embodiments, the bridge body has a height sufficient to allow saddle screw heads to be enclosed in the bridge and to protect the player's hand from the saddles and saddle adjustment screws.

In accordance with another aspect of the presently described embodiments, a two-piece fixed bridge for a stringed musical instrument comprises a bridge body machined solid from metals selected for metallurgic and sound transmission qualities and a bridge plate affixed to the bridge body anchoring the bridge body to the stringed musical instrument, wherein the bridge plate has holes aligned for through the body strings to allow selective through the body stringing for alternate string tones.

In accordance with another aspect of the presently described embodiments, the bridge plate is interchangeable to allow multiple bridge plates to accommodate various pickup and instrument configurations.

In accordance with another aspect of the presently described embodiments, the bridge body is formed in curved shapes to aesthetically complement typical instrument rounded contours.

In accordance with another aspect of the presently described embodiments, the bridge body is formed in curved shapes and to form an exposed surface area suitable for branding.

In accordance with another aspect of the presently described embodiments, the bridge body has a height sufficient to increase the mass of the bridge body.

In accordance with another aspect of the presently described embodiments, the bridge body has a height sufficient to allow saddle screw heads to be enclosed in the bridge and to protect the player's hand from the saddles and saddle adjustment screws.

### BRIEF DESCRIPTION OF THE DRAWINGS

FIG. 1 illustrates Top, Bottom, Left and Right views of 1-piece solid bridge and tremolo block;

FIG. 2 illustrates an Isometric view of 1-piece solid bridge and tremolo block;

FIG. 3 depicts a Tremolo assembly top view;

FIG. 4 shows a typical application of 1-piece tremolo bridge, tremolo block, saddle assembly, springs, and tremolo arm in the instrument;

FIG. 5 shows a Top view, Angels Music laser branded 1-piece tremolo bridge, tremolo block and saddle assembly;

FIG. 6 shows an Isometric view, Angels Music engraved branded 1-piece tremolo bridge, tremolo block and saddle assembly;

FIG. 7 shows an Isometric view, Angels Music engraved branded 1-piece tremolo bridge secured to the tremolo block;

FIG. 8 depicts a 14 mm tremolo block;

FIG. 9 depicts a 16 mm tremolo block;

FIG. 10 depicts a 14 mm piezo tremolo block;

FIG. 11 shows the existing Fender Tremolo Bridge for comparison;

FIG. 12 shows a Comparison to Fender Tremolo Bridge and Tremolo Block;

FIG. 13 shows a Bottom isometric view of the 2-part hardtail body and 3 various hardtail mounting plates;

FIG. 14 shows a Top isometric view of the 2-part hardtail body and 3 various hardtail mounting plates;

FIG. 15 shows a Back view of the 2-part hardtail body and 3 various hardtail mounting plates;

FIG. 16 shows a Front view, of the 2-part hardtail body and 3 various hardtail mounting plates;

FIG. 17 illustrates the Hardtail Bridge and plate;

FIG. 18 shows a typical application of the 2-part hardtail body and mounting plates in the instrument; and

FIG. 19 shows a typical guitar and its parts.

### DETAILED DESCRIPTION

According to the presently described embodiments, in at least one form, certain deficiencies of the prior art are overcome by machining bridges and/or tremolo blocks out of solid blocks of various metals, selected for their metallurgic and sonorous qualities. The system according to the presently described embodiments may be machined in a variety of manners. However, in at least one example form, the components of the system are machined with rounded ergonomic edges. A rounded ergonomic design protects a player's hand from the string saddles and screws. Also, in at least one form, the bridge itself is machined to visually complement typical guitar contours and provide a surface for branding. Further, in at least one form, implementation of the presently described embodiments results in a bridge and/or tremolo bridge system with greater mass than conventional systems.

The increased mass, the rounded machined solid design (as compared to existing typical bent metal bridges), and the qualities of the bridge metals (noted above as being selected for their metallurgic and sonorous qualities), or any combination thereof, contribute to improve sustain of the instrument.

The resultant bridge and/or tremolo bridge system could be used to replace existing bridges and/or existing tremolo bridge systems or implemented in new instruments. Also, the presently described embodiments provide an improved bridge and/or tremolo bridge system for a stringed musical instrument, typically, an electric guitar. Of course, other stringed instruments may also implement the presently described embodiments.

Also, it should be appreciated that the examples of the presently described embodiments are described in the context of fabricating those parts using, for example, a machining process. However, it is to be appreciated that other manners of fabrication of such components (and others described herein) may be used. For example, various molding techniques may be used to form components as an alternative to machining processes to achieve the desired components.

In at least one example form, a bridge is machined as a solid one-piece body and plate. This provides improvements over conventional systems as will be detailed below and could be implemented an improved bridge system, that is, with no tremolo component.

However, the system using this one-piece bridge system also typically includes a separate machined tremolo block and separate tremolo arm. It will be appreciated that the tremolo block and tremolo arm are configured for suitable connection to the one-piece body and plate.

In another example form of the presently described embodiments, the bridge system may be machined in two parts: as a solid body and separate mounting plate configured to be attached to the solid body.

In at least one form, saddles are added to both the one-piece design and the two-piece design to accommodate the strings of the instrument. Further, as an option, the tremolo block may be machined for piezoelectric pickup(s).

Now, more particularly, and to provide further details on the example implementations of the presently described embodiments, in at least one form, an improved bridge for stringed musical instruments is provided comprising a musical instrument bridge body, machined solid from metals selected for their metallurgic and sound transmission qualities.

The bridge body may be shaped in preferred various curves, harmoniously complementing the customary rounded contours of conventional instruments. This design may enhance the instrument's visual aesthetics and contribute to its ergonomic compatibility with musicians, thereby optimizing performance comfort.

The bridge body may be machined in preferred various curved shapes to showcase an exposed surface area that presents an ideal platform for branding, facilitating customizable artistic embellishments that can enhance the instrument's identity and appeal, enabling instrument manufacturers to incorporate branding elements seamlessly.

The bridge body's design has sufficient height, width, and length to create an increase in bridge body mass over typical designs. This augmented mass contributes to the bridge's resonance and vibration properties, enriching the instrument's tonal output.

The bridge body's height is sufficient to enclose saddle screw heads within the bridge body structure, ensuring a streamlined appearance while safeguarding against inadvertent adjustments that may affect the instrument's playability and sound quality.

The bridge body's curvature and height are configured to serve the dual purpose of enclosing saddle screw heads within the bridge body structure, ensuring a streamlined appearance, and providing a safeguard against inadvertent adjustments that could affect playability and sound quality. This design feature also offers a protective function, shielding the player's hand from potential contact with the saddles and saddle adjustment screws.

The bridge's overall composition includes both the bridge body and the bridge plate to provide a structurally sound and acoustically optimized bridge for musical instruments.

The present aspect introduces a stringed musical instrument's bridge body machined solid from metals selected for metallurgic and sound transmission qualities. The bridge's preferred various curved shapes cater to both aesthetics and ergonomics, while the height is configured to create increased mass, create player's hand protective features, and secure saddle screw enclosure. This bridge body design elevates performance, player ergonomics and comfort, aesthetics, and branding capability.

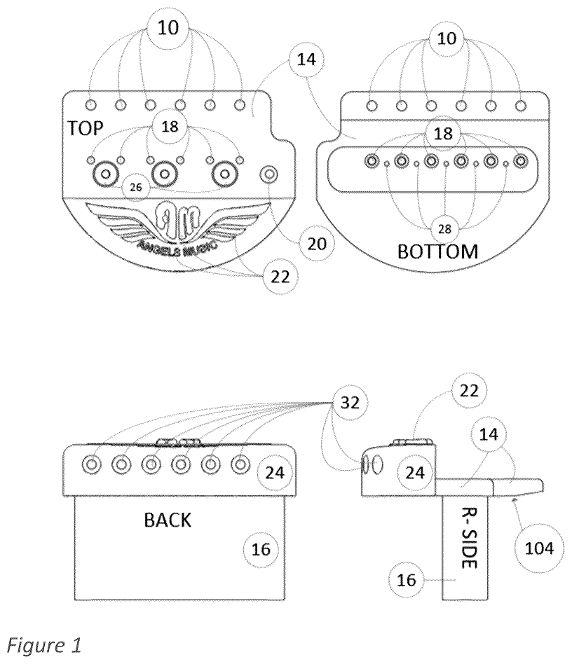

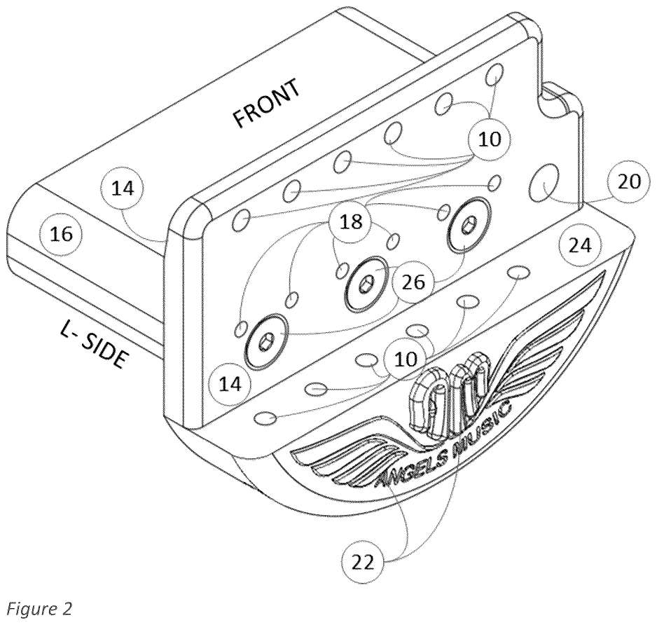

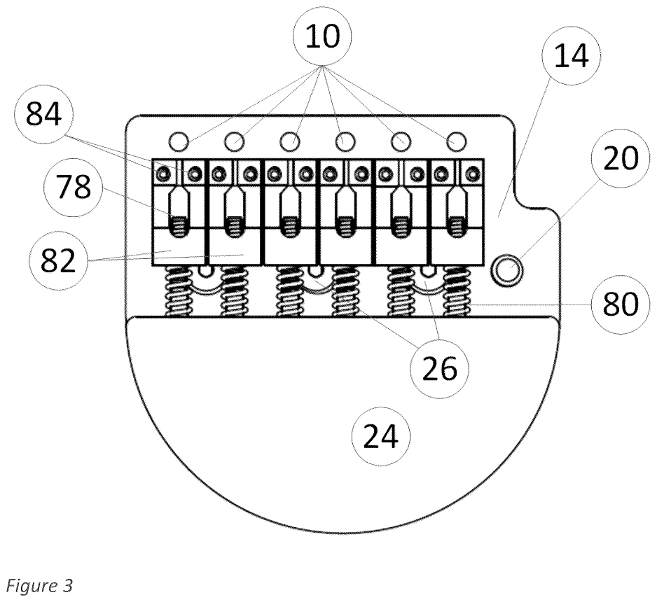

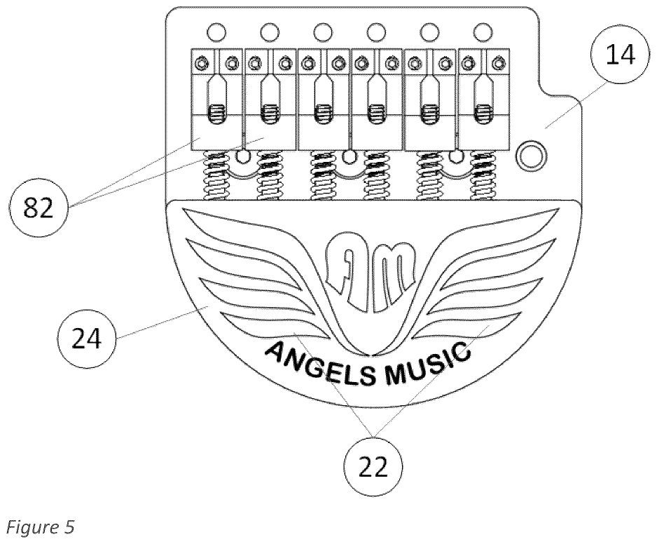

With reference now to the drawings, a bridge body is machined solid from metals in preferred various curved shapes to aesthetically complement typical instrument rounded contours. FIG. 1 illustrates a shallower type of preferred curve of the bridge body, easily seen in the top, bottom and side views and in FIG. 2, a perspective view. FIGS. 3, 5, 13 and 14 illustrate a deeper curve of the bridge body than FIGS. 1 and 2. Curved shapes are preferred, but square, rectangular, or other polygon body shapes could be machined.

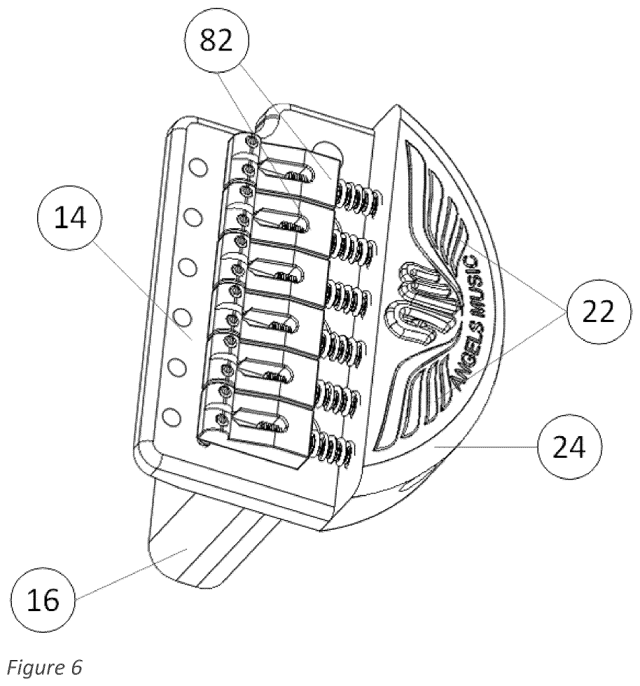

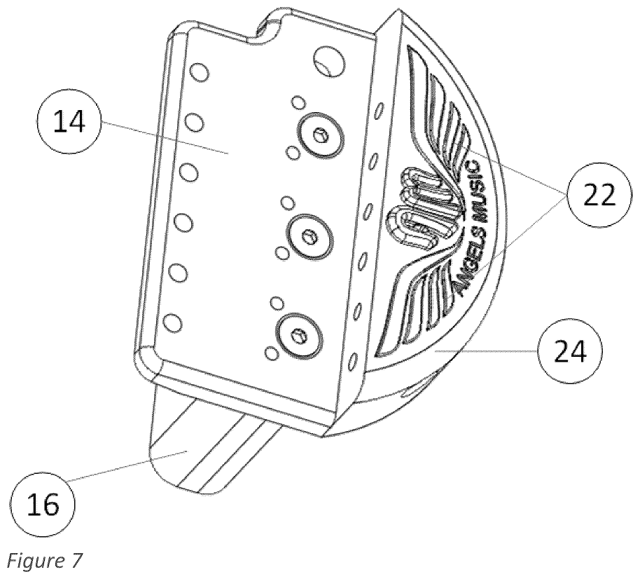

FIGS. 1, 2, 5, 6 and 7 illustrate the bridge body 24, bridge plate 14, saddles 82, and tremolo block 16 machined in preferred various curved shapes having an exposed surface area suitable for branding 22, shown as a raised, engraved or laser etched logo.

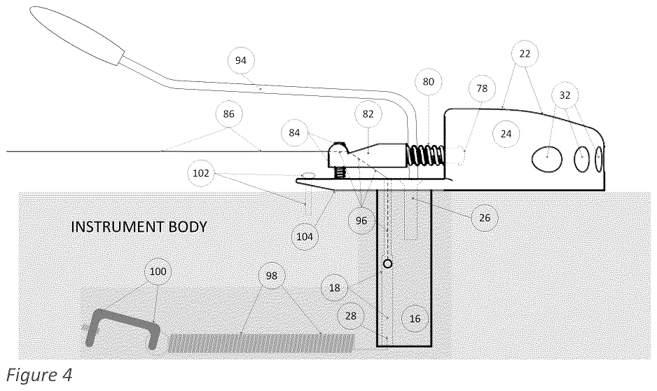

The bridge body is machined solid from metals in preferred various curved shapes with height sufficient to increase the mass of the bridge. FIG. 4 illustrates the increased height of the bridge and saddle screws 78 enclosed in the bridge. Table 1 (below) illustrates metals Including but not limited to those with the desired metallurgic and sound transmission qualities and the increase in mass of those metals for various designs.

FIG. 4 illustrates the bridge body machined with height sufficient to protect the player's hand from the saddles 82 and saddle adjustment screws 78.

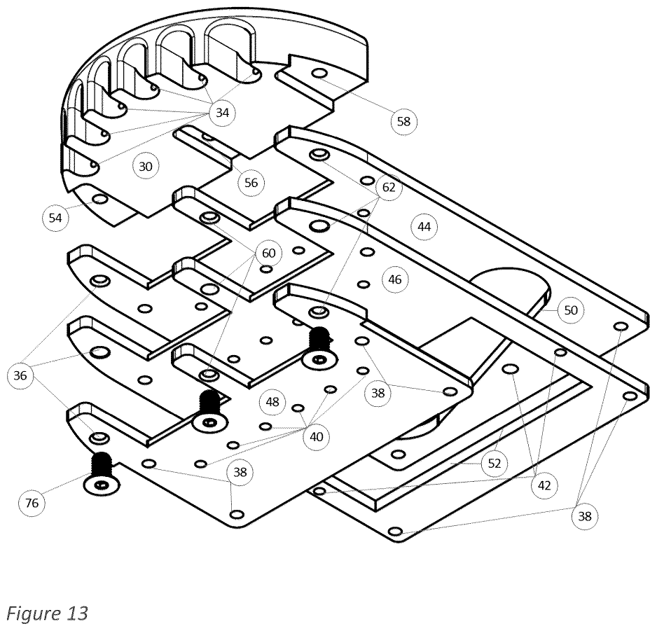

FIGS. 1 and 2 illustrate the bridge body 24, such as a 1-piece solid bridge body, or 1-piece tremolo bridge and instrument mounting plate 14 which, in one form, is formed as a part of the 1-piece tremolo bridge. FIGS. 13, 14, 15, 16, and 17 illustrate the bridge body 30, such as a hardtail bridge body, and interchangeable bridge plates 44, 46 and 48 comprising the 2-piece fixed bridge. In this regard, the bridge plates may take a variety of forms. For example, bridge plate 44 may be implemented as a hardtail plate for a Telecaster-style single pick-up, bridge plate 46 may be implemented as a hardtail plate for a Telecaster-style humbucker pickup, and/or bridge plate 48 may be implemented as a hardtail Stratocaster-style plate.

In at least one form of the presently described embodiments, a one-piece tremolo bridge designed for application in stringed musical instruments is provided. In this form, the bridge body incorporates an integrated bridge plate to anchor the tremolo bridge to the instrument's body. The integration of the bridge plate into the bridge body ensures stability and may optimize sound transmission and the instrument's tonal qualities. The bridge body and the bridge plate comprise the one-piece tremolo bridge.

A tremolo block is affixed to the underside of the bridge plate. The tremolo block, available in various widths, for more or less mass, is machined solid from metals chosen for their metallurgic and sound transmission properties.

This arrangement provides the foundation for the operation of a tremolo arm. The tremolo arm is anchored within the tremolo block. The tremolo arm functions to move the one-piece tremolo bridge and tremolo block on the one-piece tremolo bridge's pivot point, enabling synchronized movement of the bridge and the tremolo block. This movement facilitates the desired tremolo effect, allowing players to manipulate the pitch of the instrument's notes dynamically.

A tremolo block may be machined to incorporate piezo pickups. The sound transmission properties of the chosen metals combined with piezo pickup technology, accurately capture the nuanced vibrations of the instrument's strings for additional sound output, combined with the existing pickup(s) through the instrument's jack.

By combining machined solid metals with the ability to integrate piezo pickups, the present aspect offers a tremolo block that may enhance sound performance and empower musicians with enhanced electronic pickup capabilities.

The present aspect introduces a 1-piece tremolo bridge for musical instruments, featuring a bridge, a tremolo block, and a tremolo arm. The construction materials, metallurgical qualities, and accommodation for piezo pickups collectively contribute to a high-performance tremolo bridge that may elevate the musical experience and offer improved tonal capabilities.

With reference back now to the drawings, FIGS. 1 and 2 illustrate the bridge body 24 and a bridge plate or instrument mounting plate 14 comprising the 1-piece tremolo bridge. For a 1-piece tremolo bridge, the bridge plate or instrument mounting plate 14 for anchoring the instrument's strings to the body 24 of the instrument is integral to the bridge body 24.

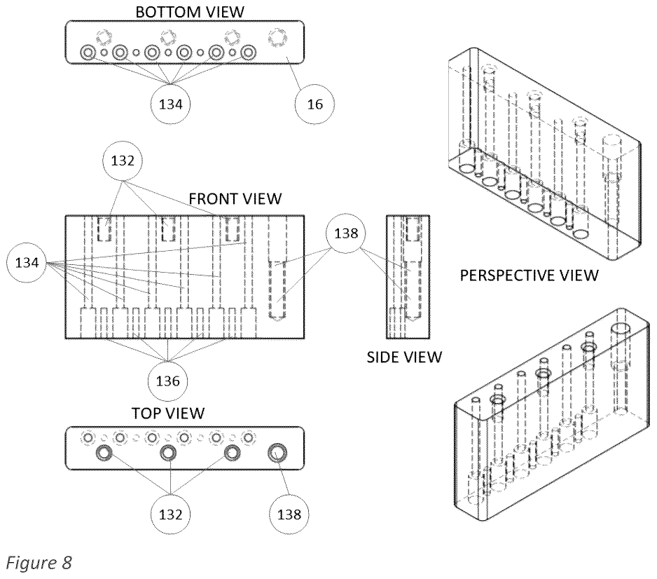

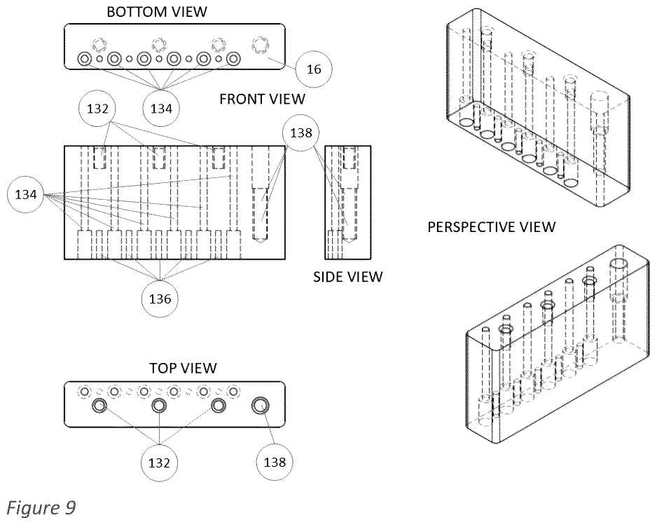

In FIGS. 1 and 2, a tremolo block 16 is rigidly attached to the bottom of the bridge plate 14 with tremolo block mounting screws 26 into tremolo block mounting screw holes 132 (see also, FIGS. 8-10). In FIGS. 1 and 2, an example tremolo block 16 is illustrated. The tremolo block 16 can be machined to various thicknesses to allow the player to select more or less mass for the desired sustain. FIG. 8 shows five views of a 14 mm tremolo block and FIG. 9 shows five views of a 16 mm tremolo block, as examples of tremolo blocks of varying widths that may be machined from solid metals selected for metallurgic and sound transmission qualities. Typical widths may be, but not limited to 14 mm and 16 mm. The tremolo block 16 is machined solid from metal. The increased mass as compared to existing typical pot metal tremolo blocks, and metallurgic and sonorous qualities of the tremolo block metals may combine to improve sustain of the instrument. There are numerous metals that can be selected for their metallurgic qualities that exceed sound speed transmission greater than 10,000 feet per second at 25° C. Table 1 illustrates metals Including but not limited to those with the desired metallurgic and sound transmission qualities and differences in mass of various designs.

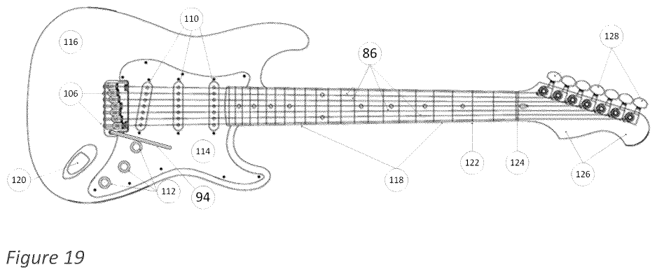

The tremolo bridge pivots on the top of the guitar body if it is set to floating. FIG. 4 illustrates the operation of the tremolo bridge. A tremolo arm 94 is inserted through the tremolo arm hole 20 in the instrument mounting plate 14 and screwed into the tremolo arm threaded mounting hole 138 in the tremolo block 16, illustrated in FIGS. 4, 8 and 9. When a player applies pressure to the tremolo arm 94, it pivots the tremolo bridge (14 and 24 are integral) and the tremolo block 16, together at the pivot point, e.g., tremolo pivot point, 104. The travel is limited by the tremolo pivot screws 102, that anchor the tremolo bridge to the body of the instrument through the countersunk solid bridge plate screw holes 10, shown in FIGS. 1 and 2. In FIG. 4, when pressure on the tremolo arm 94 is relieved, the tremolo springs 98, attached to the instrument body 116 by the spring claw 100 and to the tremolo block by the spring mounting end 28 (FIG. 4) into the tremolo block spring mounting claw holes 136, (FIGS. 8-10) returns the tremolo bridge to its original position. The instrument strings 86 are threaded through the tremolo plate string loading holes 18, FIGS. 4, 8 and 9, following the tremolo string path 96 (FIG. 4), the string path continues through the instrument mounting plate 14, (part of 1-piece tremolo bridge). In FIG. 4, the instrument string 86 continues across the saddle 82. FIG. 19 illustrates a typical solid body electric guitar. The instrument string 86 continues across the instrument pickups 110 over the frets 122 and instrument neck 118, through the nut 124 and are anchored at the other end by the tuning machines 128 on the headstock 126. The saddles 82 are adjusted for instrument string 86 length by the saddle screw 78 and for height by the saddle height adjustment screw 84. The saddle screw 78 is accessed through the saddle screw hole 32. The number of springs used are typically 3-5, depending upon the degree of float desired. If set to non-floating, the springs, such as saddle screw spring 80, serve to anchor the tremolo bridge, which improves tuning drift. A number of string saddles 82 in various metals are available to use with the bridge.

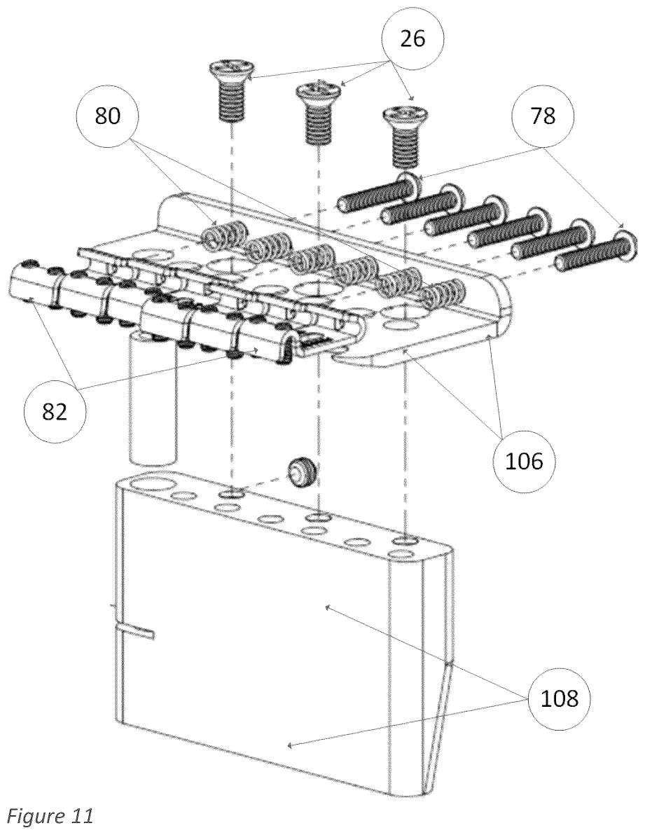

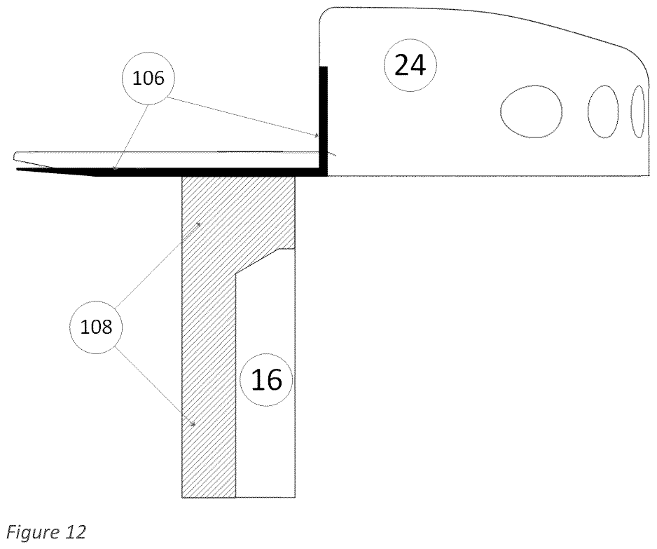

In FIG. 11, the existing Fender Tremolo Bridge, a bent metal bridge, is shown for comparison. In FIG. 12, a typical Fender Tremolo Bridge 106 and typical Fender Tremolo Block 108 are superimposed over the improved 1-piece solid bridge body 24 and the tremolo block 16. The existing Fender tremolo bridge compares to the integral bridge plate of the improved bridge, while the bridge body is non-existent on the Fender bridge. The increase in mass for both the bridge and tremolo block are obvious.

The operation of the tremolo bridge is typical in the art, as the improved tremolo bridge is meant as a direct replacement for bent metal Fender Stratocaster bridges, as well as new instruments.

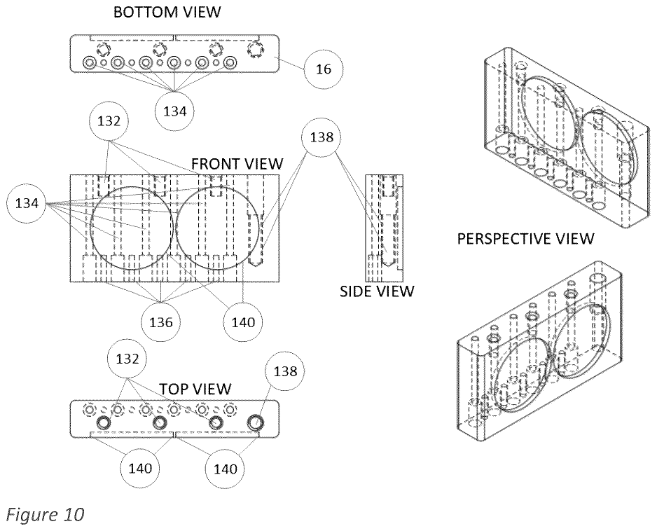

The tremolo block can also be machined to allow the mounting of piezo pickups to add electronic signal output for the instrument directly from the bridge. In FIG. 10, a piezo tremolo block is shown. It is similar to FIG. 8, a 14 mm tremolo block; however, 2 piezo machined mounting spaces 140 are provided where piezo pickups may be mounted. The piezo tremolo block is machined solid from metals selected for metallurgic and sound transmission qualities. There are numerous metals that can be selected for their metallurgic qualities that exceed sound speed transmission greater than 10,000 feet per second at 25° C. For comparison, brass used in some bridges and tremolo blocks has sound transmission of 6,923 feet per second at 25° C. Table 1 (shown below) illustrates metals including but not limited to those with the desired metallurgic and sound transmission qualities and differences in mass of various designs. Piezo pickups mounted in the piezo tremolo block are connected to the instrument tone and volume controls 112 (FIG. 19) for additional modification of the electric signal.

In another example form of the presently described embodiments, a two-piece bridge assembly for stringed musical instruments is provided, offering features that may enhance functionality, tonal expression, and adaptability of the instrument. A factor in designing the two-piece bridge is the secure attachment of an interchangeable bridge plate to the bridge body, to be able to effectively anchor the bridge to the instrument. This connection may ensure stability, sound transmission, and optimal playability.

The bridge plate's configuration offers versatility by allowing multiple plates to be machined, tailored to specific pickup and instrument configurations. This adaptability enables instrument manufacturers and musicians to customize their setups to achieve the desired sound and performance characteristics.

The bridge body may be machined with various preferred curves that aesthetically complement the instrument's contours. The curved shape along with sufficient height facilitates the enclosure of both saddle screw heads and string ends within the bridge structure. This design promotes a streamlined appearance, minimizes protrusion, and prevents entanglement.

The bridge plates incorporate strategically aligned holes, facilitating selective through-the-body string installation, for those instruments with through-the-body holes, when desired. This allows strings to be threaded through the instrument body 116, or through the bridge body, enabling alternate string tones, which may expand the instrument's sonic capabilities and enhance creative expression.

Thus, the presently described embodiments introduce a 2-piece fixed bridge for stringed musical instruments, combining a curved bridge body with a securely attached interchangeable bridge plate. With a curved and height appropriate machined bridge body, securely attached interchangeable bridge plates, adaptability for different configurations, and through-the-body stringing options, this design may facilitate precise string attachment, sound optimization, and aesthetics, while providing a solution for enclosing saddle screw heads and string ends. This may provide musicians with opportunities for sonic exploration and artistic innovation.

With reference back to the drawings, in FIG. 13, a 2-piece fixed bridge for a musical instrument is shown. The fixed (or ‘hardtail’) bridge is 2 parts: a solid machined hardtail bridge body 30 and interchangeable plates designed for different instrument pickup or mounting configurations. The plates include, but are not limited to: hardtail plate for Telecaster style single pickup 44, hardtail plate for Telecaster style humbucker pickup 46 and hardtail plate Stratocaster style 48. In at least one form, the interchangeable plate (44, 46, 48) is machined from plate stock, eliminating the need to machine the entire bridge from a large block.

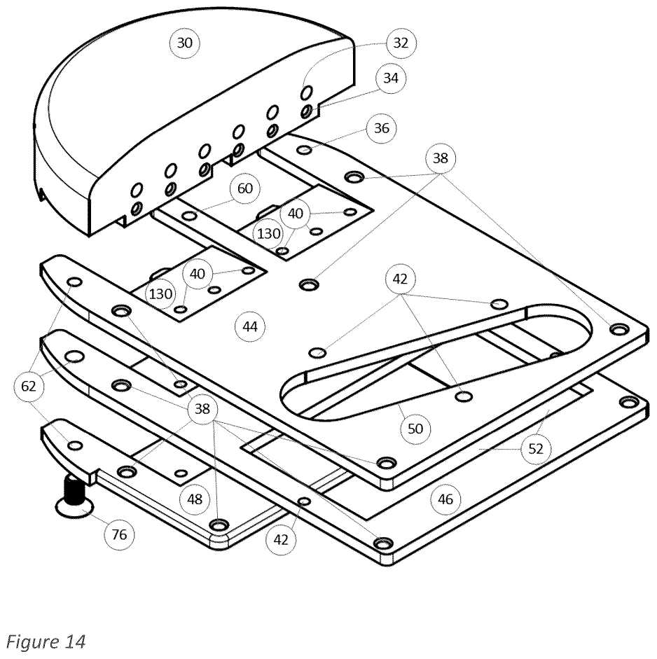

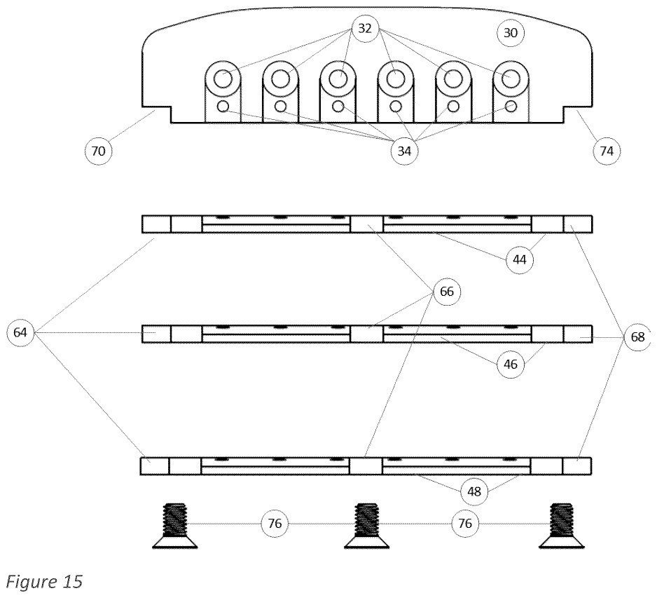

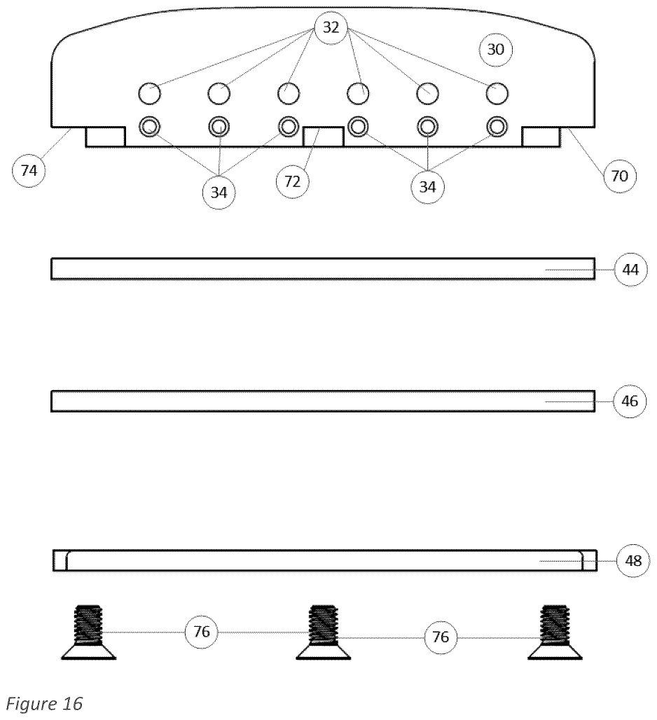

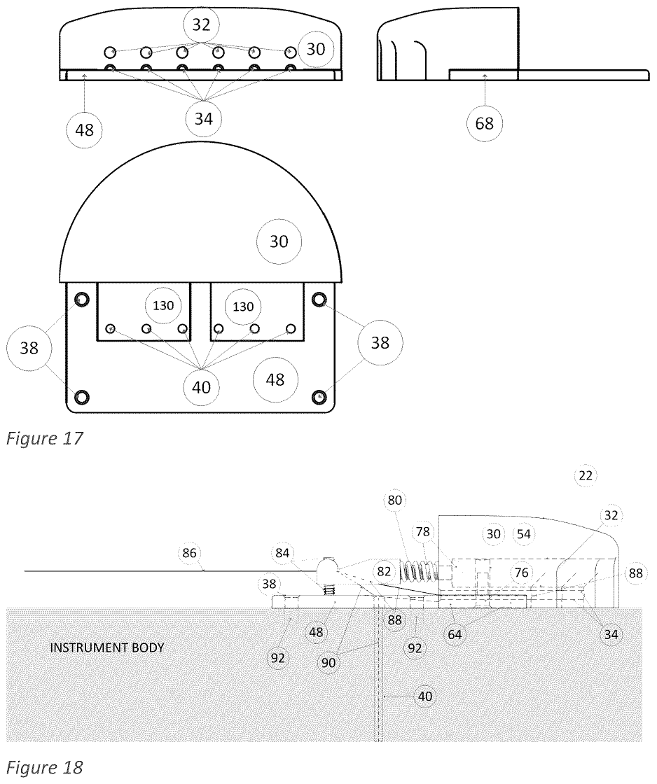

FIG. 13 is the bottom isometric view of the 2-part hardtail body and 3 various hardtail mounting plates, FIG. 14 is the top isometric view of the 2-part hardtail body and 3 various hardtail mounting plates, FIG. 15 is the back view of the 2-part hardtail body and 3 various hardtail mounting plates, FIG. 16 is the front view of the 2-part hardtail body and 3 various hardtail mounting plates, FIG. 17 is the Hardtail Bridge and plate, including a side view. Hardtail mounting plate configurations may vary and are not limited to the 3 plates illustrated.

In FIGS. 13-17 interchangeable plates are shown: hardtail plate for Telecaster style single pickup 44, hardtail plate for Telecaster style humbucker pickup 46 and hardtail plate Stratocaster style 48 are aligned to the hardtail bridge body with:
left hardtail plate tang 64 to left hardtail bridge body surface for Hardtail plate tang 70,
center hardtail plate tang 66 to center hardtail bridge body surface for Hardtail plate tang 72 and
right hardtail plate tang 68 to right hardtail bridge body surface for hardtail plate tang 74.

They are secured with hardtail plate tang mounting screws 76 through:
left hardtail plate tang mounting hole 36 to left hardtail plate to hardtail bridge body screw hole 54, center hardtail plate tang mounting hole 60 to center hardtail plate to hardtail bridge body screw hole 56, and
right hardtail plate tang mounting hole 62 to right hardtail plate to hardtail bridge body screw hole 58.

Once a plate is secured to the hardtail bridge body 30 with hardtail plate tang mounting screws 76, this comprises a 2-part fixed bridge (or hardtail bridge).

In FIG. 18, a typical application of the 2-part hardtail body and mounting plates in the instrument is shown. The fixed bridge assembly is attached to the instrument's body through the hardtail plate mounting hole to instrument body 38 with hardtail plate to body mounting screws 92. The instrument strings 86 begin in the hardtail string path 88 through the hardtail string holes 34 (also FIGS. 13-14), through the hardtail bridge body 30, over the machined ramp for string path 130 and across the saddle 82. FIG. 19 illustrates a typical solid body electric guitar. Instrument tone and volume controls 112 are typically mounted in the instrument pickguard 114, and the pickguard is affixed to the instrument. Electrical signals from the pickup(s) are modified by the controls and the output is through the instrument electric output jack 120 (FIG. 19). The instrument string 86 continues across the instrument pickups 110 over the frets 122 and instrument neck 118, through the nut 124 and are anchored at the other end by the tuning machines 128 on the headstock 126. The pickup is mounted to the hardtail plate for Telecaster style single pickup 44 in single pickup cutout in hardtail plate 50 (FIGS. 13-17), or the hardtail plate for Telecaster style humbucker pickup 46, in humbucker pickup cutout in hardtail plate 52 (see also, FIGS. 13-17), or the hardtail plate Stratocaster style 48 through the hardtail plate pickup mounting hole 42 (see also, FIGS. 13-17). The saddles 82 are adjusted for instrument string 86 length by the saddle screw 78 and for height by the saddle height adjustment screw 84. The saddle screw 78 is located in the saddle screw hole 32 (FIG. 18).

The hardtail bridge body 30 is machined in preferred various curved curves with sufficient height to allow both the saddle screw heads and the string ends to be enclosed in the bridge. FIGS. 13-18 illustrate the increased height of the hardtail bridge body 30 with saddle screws 78 and instrument strings 86 enclosed in the bridge, with the instrument strings beginning in the hardtail string path 88.

In instruments with existing through the body string holes, strings can be mounted either through the body, or through the bridge, giving different tone and sustain qualities to selected strings. FIGS. 13-18 illustrate through the body string holes 40 in the interchangeable plates, 44, 46 and 48 align with typical through the body string holes in instruments. The instrument strings 86 may begin in through the body string holes 40 and follow hardtail alternate through the body string path 90 giving different tone and sustain qualities to selected strings, as desired.

As noted above, according to the presently described embodiments, an improved bridge is machined solid from metals selected for their metallurgic and sound transmission qualities. Machining is generally, but not limited to, CNC machining using step files. Table 1 illustrates metals Including but not limited to those with the desired metallurgic and sound transmission qualities.

TABLE 1
Comparative mass of 1-piece body and tremolo blocks

| | 1-Piece | Tremolo | Total |
|---|---|---|---|
| Material | Solid Bridge | Block | Mass |
| 303 Stainless | 313 g | 330 g | 643 g |
| Bronze Bell Metal | 417 g | 330 g | 747 g |
| Aluminum | 133 g | 105 g | 238 g |
| Titanium | 222 g | 176 g | 398 g |
| Typical Bent | 64 g | 134 g | 198 g |
| (for comparison) | | | |

Metals preferred in the design have sound speed transmission qualities in excess of 10,000 feet per second at 25° C. The sonorous metallurgic quality plus the increased mass available by machining solid from a block of metal, as opposed to bent sheet stock used in typical existing designs, improves sustain of the instrument. The 1-part tremolo bridge, 2-part fixed bridge or tremolo block may be machined from various metals, including, but not limited to bronze bell metal (79% Cu, 21% Sn), 303 stainless, 304 stainless, aluminum and titanium. Others with similar qualities can be used. There are aluminum and titanium alloys with sound speed transmission greater than 10,000 feet per second at 25° C. available for lighter components if desired, that still increase mass over existing bent steel designs and have desired sonorous qualities. For comparison, brass used in some existing bridges and tremolo blocks has sound transmission of only 6,923 feet per second at 25° C.

The rounded design of the improved musical instrument's bridge (fixed or tremolo) is machined solid from metals to visually complement typical guitar contours. Its rounded ergonomic design better guards the player's hand from the string saddles, as well as from the bridge itself. Metals used in the design are selected for sound speed transmission qualities in excess of 10,000 feet per second at 25° C. The sonorous metallurgic quality plus the increased mass available by machining from a solid block of metal, as opposed to bent sheet stock used in typical existing designs, improves sustain of the instrument. String spacing and mounting holes on the tremolo or fixed bridge may vary to match the number of strings and the string spacing of the intended instrument.

The fixed (or ‘hardtail’) bridge is 2 parts: a solid machined body, and multiple interchangeable plates designed for different instrument pickup or mounting configurations. The body in 303 stainless is approximately 315 g. The plates are machined from plate stock, eliminating the need to machine the entire bridge from a large block.

For comparison, the typical imported Fender Stratocaster fixed bridge has a mass of approximately 64 g and a Telecaster fixed bridge has a mass of approximately 200 g. The preferred embodiment of the 2-part fixed bridge body and plate are approximately 391 g to 468 g, depending upon the plate configuration, for increased sustain.

The 2-part fixed bridge (or ‘hardtail’) is meant as direct replacement for existing bent metal bridges, as an improvement, as well as for use in new instruments.

Typical mass for the 1-piece solid bridge and tremolo block for indicated metals vary from 238 g to 747 g, as shown in Table 1. All metals in the table have sound speed transmission qualities in excess of 10,000 feet per second at 25° C. Different metals can be used for the 1-piece solid bridge and Tremolo Block. Tremolo blocks with different thickness can be made, allowing the player a wide range of selections for mass.

For comparison, a typical Fender Stratocaster tremolo plate has a mass of 64 g, and the tremolo (inertia) block has a mass of 134 g for a total of 198 g. The 1-piece solid bridge and tremolo block have approximately 1.2 to 3.77 times the mass of the typical Fender tremolo bridge and tremolo block, depending upon the chosen metal.

The 1-part bridge, 2-part bridge or tremolo block may have various polishing and plating finishes applied depending upon the intended appearance of the instrument. Finishes include, but are not limited to polished stainless, chrome and other plating, anodizing and powder coating.

The company logo or other identifications can be machined, engraved, or etched on the 1-part bridge, 2-part bridge or tremolo block for branding or identification purposes.

The presently described embodiments have been described with reference to various examples for implementation. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A bridge for stringed musical instruments comprising:
a bridge body machined solid from metal selected for metallurgic and sound transmission qualities, wherein the bridge body has a mass in a range of approximately 133 g to 417 g; and,
a bridge plate.

2. The bridge as set forth in claim 1 wherein the bridge body is formed in curved shapes to aesthetically complement typical instrument rounded contours.

3. The bridge as set forth in claim 1 wherein the bridge body is formed in curved shapes and to form an exposed surface area suitable for branding.

4. The bridge as set forth in claim 1 wherein the bridge body has a height sufficient to increase a mass of the bridge body.

5. The bridge as set forth in claim 1 wherein the bridge body has a height sufficient to allow saddle screw heads to be enclosed in the bridge and to protect the player's hand from the saddles and saddle adjustment screws.

6. The bridge as set forth in claim 1 wherein the bridge body and the bridge plate are integral.

7. A one-piece tremolo bridge for a stringed musical instrument comprising:
a bridge body;
a bridge plate configured to anchor strings of the stringed musical instrument strings to a body of the stringed musical instrument, wherein the bridge body and bridge plate are integral and machined solid from metals selected for metallurgic and sound transmission qualities;
a tremolo block rigidly attached to the bottom of the bridge plate, wherein the tremolo block is machined solid from metals selected for metallurgic and sound transmission qualities; and,
a tremolo arm anchored in the tremolo block configured to pivot the bridge body, the bridge plate and the tremolo block together.

8. The bridge as set forth in claim 7 wherein the tremolo block is machined to accept piezo pickup(s).

9. The bridge as set forth in claim 7 wherein the bridge body is formed in curved shapes to aesthetically complement typical instrument rounded contours.

10. The bridge as set forth in claim 7 wherein the bridge body is formed in curved shapes and to form an exposed surface area suitable for branding.

11. The bridge as set forth in claim 7 wherein the bridge body has a height sufficient to increase a mass of the bridge body.

12. The bridge as set forth in claim 7 wherein the bridge body has a height sufficient to allow saddle screw heads to be enclosed in the bridge and to protect the player's hand from the saddles and saddle adjustment screws.

13. A two-piece fixed bridge for a stringed musical instrument comprising:
a bridge body machined solid from metal selected for metallurgic and sound transmission qualities; and,
string holes in the bridge body, and,
a bridge plate affixed to the bridge body anchoring the bridge body to the stringed musical instrument, wherein the bridge plate has holes aligned for through the body strings to allow selective through the body or bridge stringing for alternate string tones.

14. The bridge as set forth in claim 13 wherein the bridge plate is interchangeable to allow each of a plurality of bridge plates to be selectively coupled to the bridge body whereby various pickup and instrument configurations are accommodated.

15. The bridge as set forth in claim 13 wherein the bridge body is formed in curved shapes to aesthetically complement typical instrument rounded contours.

16. The bridge as set forth in claim 13 wherein the bridge body is formed in curved shapes and to form an exposed surface area suitable for branding.

17. The bridge as set forth in claim 13 wherein the bridge body has a height sufficient to increase a mass of the bridge body.

18. The bridge as set forth in claim 13 wherein the bridge body has a height sufficient to allow saddle screw heads to be enclosed in the bridge and to protect the player's hand from the saddles and saddle adjustment screws.

19. The bridge as set forth in claim 1 wherein the metal is at least one of the following: stainless steel, bronze bell metal, aluminum or titanium.

20. (canceled)

21. The bridge as set forth in claim 1 wherein the metal has sound speed transmission qualities in excess of 10,000 feet per second at 25 degrees Celsius.

22. A bridge for stringed musical instruments comprising:
a bridge body formed solid from metal selected for metallurgic and sound transmission qualities defined at least by sound speed transmission qualities in excess 10,000 feet per second at 25 degrees Celsius, wherein the bridge body has rounded ergonomic edges configured to protect a hand of a player from the string saddles and screws; and,
a bridge plate.

23. A tremolo bridge system for a stringed musical instrument, comprising:
a solid bridge body formed as a unitary structural component and configured to be mounted to a surface of an instrument body;
a tremolo block rigidly coupled to the bridge body such that the bridge body and the tremolo block move together relative to the instrument body during tremolo operation;
a bridge plate coupled to the bridge body; and,
a plurality of individual string saddles positioned on the bridge plate and adjustably mounted to the bridge body with adjustment screws;
wherein strings are anchored within the tremolo block and extend across the plurality of individual string saddles.

24. The tremolo bridge system of claim 23, wherein height adjustment screws associated with each string saddle are shielded by the bridge body such that the screws do not protrude above an upper surface of the bridge body in a region contacted by a player's hand during use.

25. A fixed bridge system for a stringed musical instrument, comprising:
a solid bridge body formed as a unitary structural component and configured to be rigidly mounted to an instrument body;
a plurality of individual string saddles positioned on a bridge plate and adjustably mounted to the bridge body with adjustment screws; and,
a removable bridge plate coupled to an underside of the bridge body and configured to mount the bridge body to the instrument body, the bridge plate defining at least one pickup configuration;
wherein the removable bridge plate is interchangeable with alternative bridge plates having different pickup configurations; and,
wherein strings extend across the plurality of individual string saddles.

26. The fixed bridge system of claim 25, wherein height adjustment screws associated with each string saddle are shielded by the bridge body such that the screws do not protrude above an upper surface of the bridge body in a region contacted by a player's hand during use.
